(19) United States
(12) Patent Application Publication
(10) Pub. No.: US 2007/0298862 A1
(43) Pub. Date: Dec. 27, 2007

(54) Method and apparatus for configuring a gaming device

(76) Inventor: Roger Thomas Kidneigh, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 11/475,388

(22) Filed: Jun. 26, 2006

(51) Int. Cl. A63F 13/00

(52) U.S. Cl. 463/20

(57) ABSTRACT

A method and apparatus for configuring a gaming device that provides a contiguous scene for a game outcome. The contiguous scene is divided into a plurality of image elements and these image elements are assigned to various locations on either a stepper motor reel assembly or a virtual reel. A winning game outcome may then result when the individual image elements are displayed along a common payline to form a complete contiguous scene. The contiguous scene may be further enhanced by the addition of embedded animation or video. Additionally, the contiguous scene may also be enhanced by association with player preferences stored within a player tracking system.

### FIELD OF THE INVENTION

The present invention relates to gaming machines, and in particular to a method and apparatus for forming an image from adjacent positions on a mechanical or video slot reels.

### RELATED ART

Games of chance have been enjoyed by people for many years and have undergone increased and widespread popularity in recent times. As with most forms of entertainment, some players enjoy playing a single favorite game, while others prefer playing a wide variety of games. For many players, playing new games adds to the excitement of “gaming.” As is well known in the art and as used herein, the terms “gaming” and “gaming devices” are used to indicate that some form of wagering is involved, and that players must make wagers of value, whether actual currency or some equivalent of value, e.g., token or credit. This is in contrast to the playing of non-wagering games, which implies the absence of a wager of value, and the capability of returning a payout; and in which skill is ordinarily an essential part of the game.

One popular gaming system is a slot machine. Conventionally, a slot machine is configured for a player to wager something of value, e.g., currency, house token, established credit or other representation of currency or credit. After the wager has been made, the player activates the slot machine to cause a random event to occur. The player wagers that particular random events will occur that will return value to the player. A standard slot machine has a plurality of spinning reels which ultimately stop to display a random combination of some form of indicia, such as numbers or symbols. If this combination contains one or more pre-selected winning combinations, the gaming device releases money into a payout chute or increments a credit meter by the amount won.

There are many different techniques for generating the various combinations that may be displayed and which determine payouts in a slot machine. The standard technique for slot machines uses mechanical or electromechanical reels with symbols distributed over the face of each reel. When the reels are spun, each reel eventually stops, displaying a combination of symbols arranged along one or more lines commonly referred to as a paylines. By appropriately distributing and varying the symbols on each of the reels, the random occurrence of predetermined winning combinations can be provided in mathematically predetermined probabilities. By clearly providing specific probabilities for each of the pre-selected winning outcomes, precise odds that control the amount of the payout for any particular combination and the percentage return on wagers for the house can be precisely controlled.

With the advent of increasingly sophisticated computer hardware and software, electronic gaming devices have been developed which eliminate the need for mechanical reels found in early gaming devices. At first, electronic gaming devices imitated or simulated the mechanical slot games in the belief that players would want to play only the same games. Early electronic gaming device systems, therefore, were simulated mechanical slot machines. These devices may include video simulations of three reel video slot machines, to five reel slot machines with a choice several distinct pay lines.

Gaming is typically considered a form of entertainment and as such colorful or whimsical symbols or figures are utilized on the reels of the gaming machine. Payouts were provided for certain specific symbol combinations on the payout line. Certain symbols became traditional on mechanical gaming machines (e.g., slot machines) such as the number “7,” cherries, bells, oranges, lemons, plums, etc.

One drawback of existing systems is that over time, players become less enthusiastic about playing with and seeing the same symbol sets. As can be appreciated, for even the more dedicated player, seeing the same bar and cherry symbols over and over again decrease their desire to play. In time, less traditional symbols were added but the play of the reel oriented slot machine game remained essentially the same. As a result, this may lead to a reduction in player interest in slot gaming, which in turn will lead to a drop in machine revenue.

One proposed solution is to simply change the top and belly glass on the machine to stimulate player interest by creating the appearance of a new game. This proposed solution did not adequately address the problem however because the game was still essentially the same but with new glass, top and bottom. Thus, a cycle of converting a gaming device occurred on a frequent basis because the entertainment value or entertainment life of the new glass can be quite short.

Other solutions included changing symbols to represent cartoon characters (i.e. Garfield® slot machine by Progressive Gaming International Corporation) or what are known as “Pokies” in Australia which use A, K, Q, 10, and 9 symbols in the reels (i.e. Loco Loot by Aristocrat).

In view of the above, what is needed is a gaming device which provides a higher level of player excitement and interaction.

### SUMMARY

To overcome the drawbacks of the prior art and provide additional benefits, a method and apparatus disclosed herein for presenting a game outcome comprised of a composite image form across two or more reels and made up of image elements located on the reels. By forming a composite image across two or more reels, instead of just presenting different symbols on each reel, a player is provided a composite image as an indicator of a win and to increase player excitement.

In one embodiment, a gaming device is provided and configured with a housing that encloses a game display area. The game display area comprises an opening in the housing. Also part of this embodiment is a payline designator associated with the game display area and plurality of reels viewable through the game display area. On the plurality of reels are two or more image elements such that when the two or more image elements are combined a composite image is formed. Also part of this embodiment is a game processor configured to generate a game outcome and two or more stepper motors configured to spin an associated reel to cause the reels to display the game outcome though the game display area. In this embodiment at least one game outcome comprises a composite image formed from two or more image elements on the reels.

It is contemplate that a top award may be associated with all of the reels displaying a game outcome that comprises a composite image formed from an image element contributed from each reel. In addition, the composite image may be related to a theme associated with the gaming device. In one embodiment, the game outcome comprises a composite image that contains less than all of the image elements. The gaming device may further comprise two or more different image elements located on the two or more reels, which may be combined based on game outcomes to form a different composite image. Likewise, the gaming device may further comprise two or more different image elements located on two or more reels such that at least one game outcome comprises two composite images being shown through the game display area.

Also disclosed herein is a method of presenting a game and indicating a top award to player using a composite image. This example method comprises providing a gaming machine having two or more physical or two or more video simulated reels and then accepting a wager from a player. The method of operation then generates a game outcome and displays the game outcome to the player on the two or more physical reels or two or more video simulated reels. The method also provides an award to the player if the game outcome displayed to the player comprises a composite image formed from two or more adjacent image elements displayed on the two or more physical reels or two or more video simulated reels.

In one variation the composite image comprises or changes into an animate or video scene. In addition, the composite image may be associated with a player preference. In one embodiment the composite image is formed from two or more image elements located on adjacent reels of the two or more physical reels or two or more video simulated reels. In one embodiment a top award is awarded to the player if the composite image is formed from image elements located on all reels of the two or more physical reels or two or more video simulated reels.

Also disclosed is a retrofit kit for retrofitting a slot type gaming machine to permit display of a composite scene as a game outcome. This kit may be used to replace components of an outdated gaming machine. This kit may comprise top glass having a theme associated therewith and a belly glass having the theme associated therewith. In addition, two or more reel graphics sheets are associated with each reel of the gaming machine and configured to replace or cover pre-existing reel graphics. At least two of the reel graphics sheets comprise two or more symbols printed on each reel graphic sheets and one or more image elements printed on at least two of the reel graphic sheets such that the one or more image elements are associated with the theme. In this kit, the two or more reel graphics sheets may be configured to display a composite image formed from at least two of the image elements printed on the reel graphic sheets.

In one variation the kit further comprises audio data associated with the theme and the kit also comprises two or more reels. In one embodiment the top glass or the belly glass further includes a top award payout amount printed thereon that is associated with a game outcome that displays the composite image displayed across all reels.

The kit may also be utilized in the following manner, namely, replacing a top glass element of the gaming machine and replacing a belly glass element of the gaming machine. Also part of this method is replacing or covering each existing reel graphics with reel graphic replacements such that the reel graphics replacements include at least one image element on each reel graphics replacement. This method also comprises arranging the reel graphic replacements and the reels in the gaming machine such that a winning game outcome results in at least one image element from each reel being displayed in a payline to thereby form a composite image.

In one variation, the top glass, the belly glass and the image elements are related to a common theme. This method may further comprise replacing an audio file with a new audio file.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a perspective view of a gaming device.

FIG. 2A is a block diagram of gaming system having electro-mechanical reels.

FIG. 2B is a block diagram of gaming system having video simulated reels.

FIG. 3A illustrates a game display area for an electro-mechanical gaming device showing a composite image across a payline.

FIG. 3A illustrates a game display area for an electro-mechanical gaming device showing a composite image across a portion of the payline.

FIG. 4 illustrates a game display area showing video simulated reels.

FIG. 5A through 5C illustrate a series of game display areas showing an animated gaming outcome as displayed on video simulated reels.

### DETAILED DESCRIPTION

In the following description, numerous specific details are set forth in order to provide a more thorough description of the present invention. It will be apparent, however, to one skilled in the art, that the present invention may be practiced without these specific details. In other instances, well-known features are indicated but have not been described in detail so as not to obscure the invention.

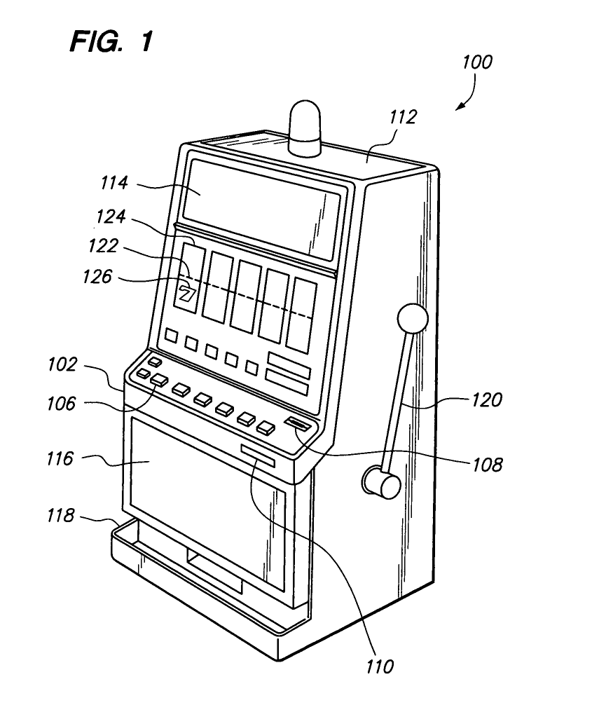

FIG. 1 illustrates an embodiment of the invention. As seen in FIG. 1, a gaming device 100 includes a game housing 102 and a game display area 104. The gaming housing 102 contains necessary hardware and software, currency handling and other components to enable play of the device. The game display area 104 is the primary area where the game communicates with the player and provides visual content relating to the play of the game. Typical player controls 106 are mounted on housing 102 in a position comfortably accessible to a player. These player controls 106 typically include a spin button, a help button, a change button, a play/credit button, a bet max button, a cash out button, a coin insert slot 108, and a currency insert slot which may also accept tickets which represent cash 110. The spin button initiates the play of the game. The help button, if so configured, provides instructions and information relating to play of the game such as rules and payoff amount related to game outcomes. The change button summons gaming establishment personnel for making change. The play/credit button enables the player to place a wager. The bet max button enables a player to place the maximum wager for the game. The cash out button redeems gaming device credits for currency or a ticket. The coin insert slot 108 is for inserting coins into the gaming device. The currency insert slot 110 allows the player to use paper currency or a ticket in place of coins to establish a credit base from which to place a wager.

The gaming apparatus 100 further includes an upper gaming housing, commonly referred to as a top box 112, an upper graphics 114, and a lower graphics 116, commonly referred to as top glass and belly glass. The top box 112 contains additional gaming device components and provides a viewing region for presenting additional graphics to the player. The lower graphics 116 provide a graphical display area where various graphics may also be shown to the player.

During play, of a “slot” type game the player attempts to receive certain combinations of slot symbols which are considered winning combination of symbols. In particular, a preferred embodiment, a one or more winning sets of symbols that the player is presented comprises a combination of symbols that, when viewed as a whole, depict a scene that spans across two or more displayed symbol positions to thereby form a visual scene larger than a single reel position.

In one embodiment, the gaming device 100 may be configured as a video type gaming machine, the machine including at least one game display area 104 for displaying game information to a player such as simulated reels which contain symbols or portions of a larger image. As described below, this game information may include standard and non-standard symbols or indicia 126.

The gaming device 100 may include other means for providing information to a player. For example, speakers (not shown) or other devices may be provided for generating sound associated with the game. The gaming device 100 may also include lights, printed instructions and other displays/display devices.

In one embodiment, a player must make payment in order to be entitled to play the game. Preferably, the game is presented as a wagering type game, and a player must place a bet or wager in order to play the game for the opportunity to receive winnings. Preferably, if the player is a winner of the game, the player is provided an award, such as a monetary payout, credits representing monetary value, points or tangible prizes. As illustrated, the gaming device 100 may include a bill validator/acceptor/ticket acceptor 110 for accepting paper currency and a coin acceptor 108 for accepting coins. Other means of payment, such as a credit card reader, may be provided. An award of winnings in the form of coins may be paid to the player via a coin tray 118.

The gaming device 100 may include means for a player to provide input for engaging in play of the gaming device 100 and the inputs are commonly referred to as player controls. These player controls 106 typically include a spin button, a help button, a change button, a Play/Credit button, a Bet Max button, a Cash Out button, a coin acceptor or insert slot 108, and a currency insert slot or bill validator and/or acceptor 110. The spin button initiates the play of the game. The help button provides instructions and information relating to play of the game such as rules and payoff amount related to game outcomes. The change button summons gaming establishment personnel for making change. The Play/Credit button enables the player to place a wager. The Bet max button enables a player to place the maximum wager for the game. The Cash Out button redeems gaming device credits for currency. Other means of input may be provided, such as a touch-screen display and other devices now known or later developed.

As indicated, in one embodiment, game information is displayed by a video version of the game display area 104 to a player. That video display may be of a variety of types, including CRT, LCD, plasma and any other means of displaying game information. The gaming device 100 may also include more than one video display.

In one embodiment, as described in more detail below, game information which is presented to a player comprises a plurality of reels 124 displaying game symbols 126. As indicated, these symbols 126 may alternatively be simulated video displays in graphical representation of the reel 124 on the game display area 104.

In a physical reel configuration 124 means are provided for rotating the physical reels 124. In one or more embodiments, the means may comprise a mechanical linkage associated with a spin arm 120. A user may pull the spin arm thereby causing the reels 124 to spin. In such an arrangement, the reels 124 are generally allowed to free-wheel and then stop. In another embodiment, electronically controlled mechanisms are arranged to rotate and stop each reel 124. Such mechanisms are well known to those of skill in the art and are commonly referred to as stepper motors or other electro-mechanical system. In this arrangement, actuation of the spin arm 120 or depression a spin button causes a game processor (not shown) to activate the spin mechanism associated with one or more of the reels 124 in response to a random number or other signal. Preferably, the processor is arranged to either turn off the signal to the device(s) effecting the rotation of each or all of the reels 124 or generates a signal for activating a braking device, whereby the reels 124 are stopped. In one embodiment a processor output controlled by or based on a random number is provided to a controller, which in turn controls the stepper motor to stop each reel in the desired position. As is well known, the combinations of reel positions and the odds of receiving a winning combination are determined by the processor, and the processor output controls the reel position to thereby display a combination of indicia. The principal of such an arrangement is described in U.S. Pat. No. 4,448,419 to Telnaes, which is incorporated herein by reference.

The gaming device 100 may have other configurations, including other features. For example, the gaming device 100 may include a player tracking device (not shown), such as a card reader and/or associated keypad. Such player tracking devices are well known and may permit the game operator to track play associated with a player of the gaming machine. The tracked play may be utilized to offer player bonuses, awards or to custom configure the gaming device with player preferences such as player favored visual elements.

In one embodiment, the gaming device 100 may be configured to dispense media, such as printed paper tickets, which have associated value. For example, winnings or unused credits may be returned to the player via a printed ticket having value or associated value. In one embodiment, the gaming device 100 might also be configured to accept such media for providing credit for game play. Such “ticket in/ticket out” systems are well known and thus not described in detail herein.

A player may provide value to the gaming device 100 or machine operator in a number of ways, including with coins or bills. The player might also be permitted to provide value remotely.

Once the player provides value, the player preferably places a wager to play the game. This may be accomplished, in one embodiment, by the player pressing the “bet one” button or the “bet max” button, or by other player input means.

Preferably, in response to the player placing a wager (or other or additional input, such as player input to a “spin” button or rotation of a handle or spin arm 120), a plurality of symbols or indicia are displayed to the player. The processor of the gaming device 100 is configured to randomly select or generate the symbols 126 for display. Methods of generation/selection are well known and may include the generation of random numbers which correspond to symbols for display.

The symbols 126 are displayed to the player. In one embodiment, display of the symbols is via the simulated video version of the game display area 104. In another embodiment, the display of the symbols 126 could be by one or more physical devices, such as physical reels 124, or a combination of physical reels 124 and virtual reels displayed by a display.

Preferably, the outcome of the game is dependent upon the arrangement of symbols 126 which are generated and displayed to the player. In particular, certain combinations of symbols preferably comprise pre-determined winning combinations of symbols. Conversely, other combinations of symbols are losing combinations.

As detailed below, the symbols may be displayed in a variety of formats or arrangements. In an embodiment of the invention where the symbols are displayed by a video display, the symbols are preferably displayed in a plurality of reel-type columns similar to the manner symbols are displayed by physical rotatable reels 124 in well-known slot machines. In such a configuration, each column may display a plurality of symbols. In one common configuration, five (5) columns of three (3) symbols, thus comprising a three (3) by five (5) matrix of symbols (such as representative of five reels each displaying three positions of symbols), are displayed. Any number of reels, either actual or simulated, may be displayed.

An outcome of the game is determined by or from the combination of symbols which is generated and/or displayed. In one embodiment, one or more combinations of symbols are declared “winning” combinations. Those combinations may be referred to as “predetermined winning combinations,” since it is predetermined that those combinations, if generated as a result of game play, comprise winning combinations.

A determination is made, in at least one instance, with respect to symbols 126 appearing along paylines 122 and, preferably, active paylines. In this context, active means that the player has placed a sufficient wager to activate the payline 122. Thus, the active payline is included in determining if a winning combination of symbols 126 has been generated.

A minimum wager may activate one or more paylines 122, while larger wagers may activate additional or all of the paylines 122. For example, there may be five (5) paylines and the player may be permitted to place a wager of one (1) to five (5) credits. In such a configuration, one (1) payline may be activated for each credit which is wagered. Thus, all five (5) paylines would only be activated in the event the player wagered a five (5) credit wager minimum.

In one embodiment, the generated symbols 126 are displayed with reference to one or more paylines 122. Preferably, paylines 122 define groups of two or more symbol 126 locations. The symbols may be displayed in a matrix format. In such instance, the paylines 122 may be linear or non-linear. For example, the paylines may be common straight horizontal lines, or may be vertical, diagonal, “V” or other shapes and or configurations. Preferably, one or more symbols 126 are displayed with reference to one or more of the paylines 122.

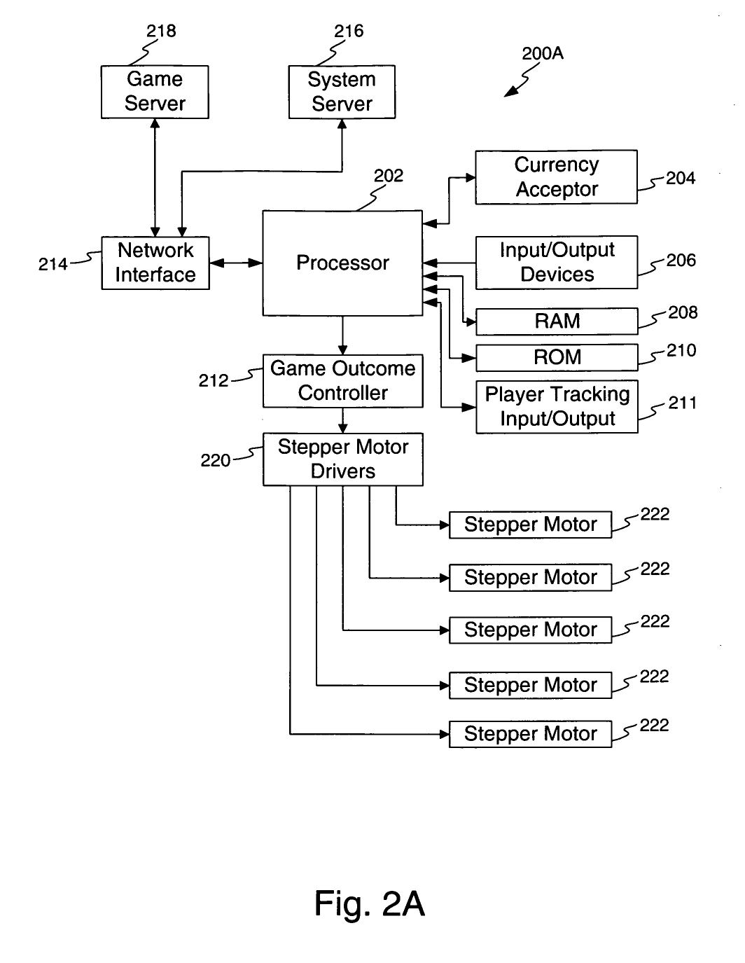

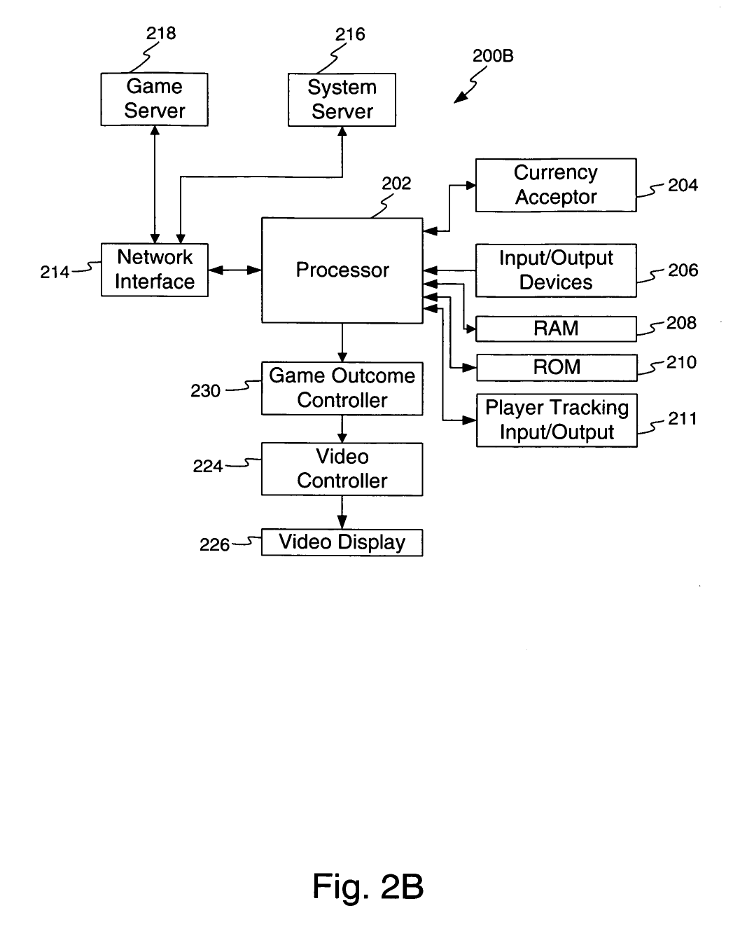

FIG. 2A is a block diagram illustrating a system 200A configured within an electro-mechanical version of gaming device to facilitate game play. A game processor 202 is provided for controlling the various components of the gaming device and determining game outcomes. In one embodiment the processor 202 generate random numbers.

The processor 202 communicates with numerous peripheral devices. One such peripheral device is a currency acceptor 204 which may include a ticket acceptor and/or coin acceptor and/or a bill validator that accepts currency for registering credits on the gaming device. The game processor 202 may be arranged to detect a signal for causing a coin delivery mechanism, such as a coin hopper (not shown) to deliver coins to the coin tray as payment of winnings or redemption of credits to a player.

Preferably, the gaming device has one or more input/output devices 206 that provide information to the game processor 202 for use in play of the game. For example, in response to a “bet one” input by a player, the game processor 202 receives a signal which causes the game processor to initiate presentation of the game. The game device further includes memory, such as random access memory (RAM) 208 and read only memory (ROM) 210 that facilitates game processor 202 operation. Additional memory, such as a hard drive may also be present.

A player tracking input/output 211 is provided on the gaming device and may be in communication with the processor as shown. The player tracking I/O 211 facilitates information gathering and data acquisition for a particular player. Such systems are well known and thus not described in detail herein.

Additionally, the game device has a game outcome controller 212 that processes the game outcomes from the processor 202 to create stepper motor control signals. The game processor 202 may be arranged to generate a game display output for presentation of game outcomes associated with the gaming device. The game outcomes are provided to the controller 212, which translates the game outcome to individual motor control signals. In turn, the stepper motor driver 220 receives the output from the controller 212 and generates signals that activate and drive the various stepper motors 222 of the gaming device. As can be appreciated, due to the power requirements of each stepper motor 222, a driver 220 may be required to sync sufficient current.

The gaming device may have a variety of configurations and additional components such a network interface 214 for sending and receiving game information. For example, a remote system server 216 may interface with the gaming device to facilitate functionality such as player tracking, accounting and ticket-in/ticket-out processing.

In addition, a remote game server 218 may generate game related information, such as game outcomes, which are then transmitted over a communication link to the gaming device. The gaming device may be thin client (ie dumb terminal) or in a downloadable format (ie where the games are downloaded and the random number resides on the terminal). That information may be utilized by a local gaming device 100 game processor 202 to present a game to a player. Any amount of type of game information or control information may be generated at the game server 218 or system server 216 and transmitted to the gaming device.

FIG. 2B is a block diagram illustrating a system 200B configured within a video simulated reels. The embodiment presented in FIG. 2B is similar to the description provided in FIG. 2A. Similar elements are identified with identical reference numbers and are not discussed again. This embodiment differs in the game outcome controller 230 and implementation of visually presenting the game outcome to a player. In this embodiment the game processor 202 may be arranged to interface with the game outcome controller 230 to present game outcomes of the gaming device. The game outcome controller 230 generates operative singles that are sent to a video controller 224. In turn, the video controller 224 generates signals for display on a video display 226 that is operatively associated with the gaming device. On the video display 226, various game outcomes are visually represented to the player. The representation may be in a visually similar format as the electro-mechanical reel embodiment; however there are no actual physical electro-mechanical reels, rather a plurality of processor simulated reels shown on a video display.

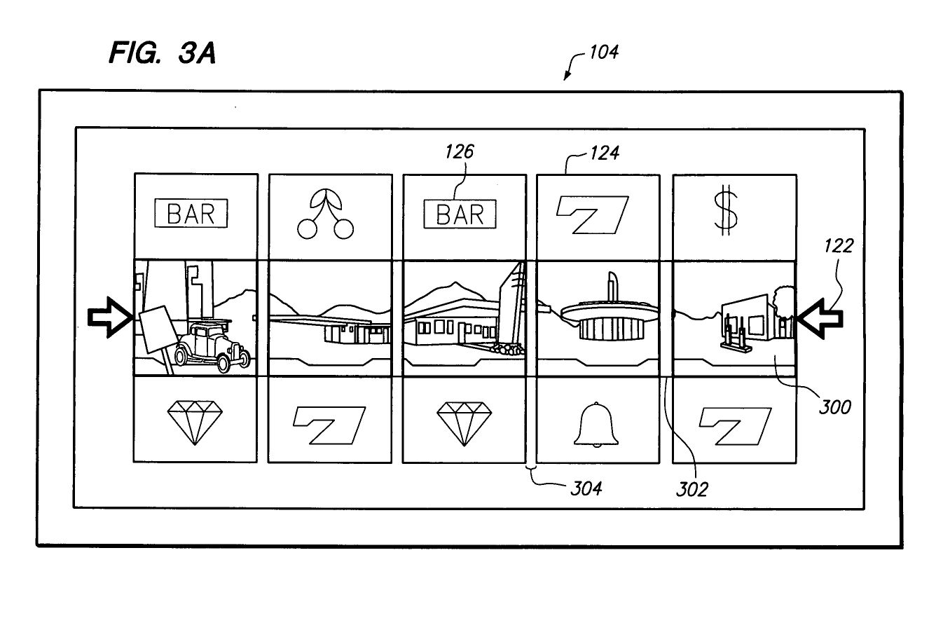

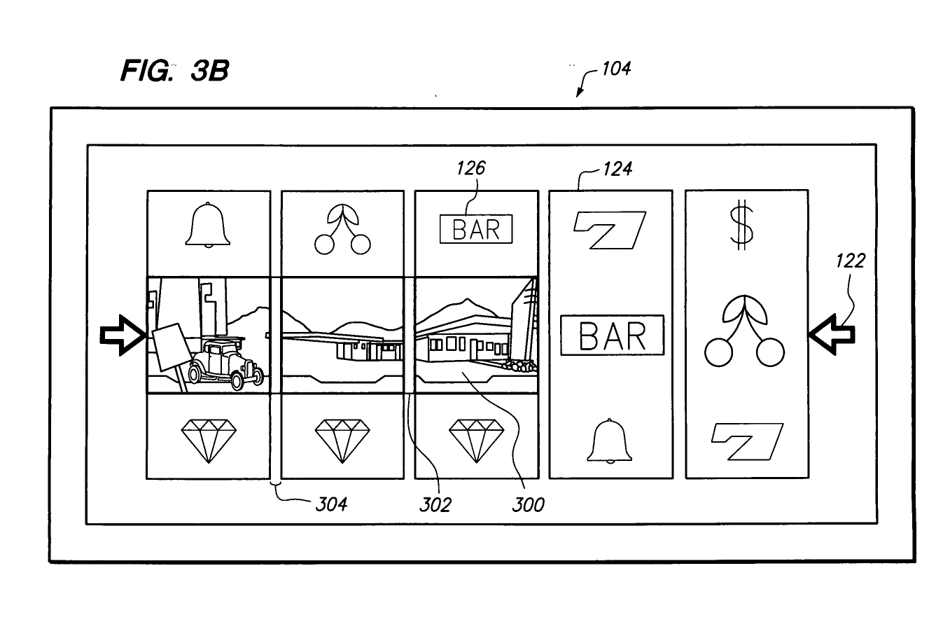

FIG. 3A illustrates a game display area for an electro-mechanical gaming device. In the embodiment illustrated in FIG. 3A, a plurality of game reels 124 are shown in game display area 104. Each of the game reels 124 contains a plurality of game symbols 126. A game outcome is determined by specific arrangement of the game symbols 126 along at least one payline 122. When a player activates the gaming device 100 of the present invention, the game processor generates an outcome for the game and then displays this outcome to the player in the game display area 104. The stepper motors or other means control the position of each reel.

In one embodiment, the game device further includes a plurality of image symbols 300 that when align across reels form a composite image. The image symbol 300 comprises part of a contiguous scene 302 when viewed in succession across two more reels. The contiguous scene 302 spans the distance of a payline 122 and is subdivided in this figures to occupy one game symbol location 126 on each of the game reels 124. For example, the contiguous scene 302 is shown as comprised of a panoramic image of a street scene with a car driving in front of buildings with mountains in the background. As can be seen, the mountain form a continuous range as does the street at the bottom of each image element 300. As can be appreciated, in high resolution graphics, the composite scene would appear more clearly. In this example embodiment the composite scene is formed from 5 individual image elements 300. When combined in a particular order the image elements form a larger composite image.

Each regions or image element is assigned to a game symbol location 126 on a game reel 124. When the image symbols 300 are displayed in order across a payline 122, the sunset scene is complete and the player can enjoy the visual representation of the sunset. Further, in accordance with the present invention, a game outcome that provides a complete contiguous scene 302 comprised of sequential image symbols 300 may be considered a top award and provides the player with an enhanced or increased award. It is further contemplated that less than all the image elements of the overall scene may represent a winning outcome. For example, a two single image elements in adjacent position may represent a winning hand, althought he payout may be related to the number of image elements, whether adjacent or not, which are on an activated pay line, or the primary pay line.

In the embodiment as depicted in FIG. 3A, the spacing 304 between game reels 124 is preferably minimized. The contiguous scene 302 spans across spacing 304 and although eliminating the mechanical reel spacing 304 may not be possible, minimizing the distance between game reels 124 will assist in blending the image symbols 300 together to visually form one complete scene. The human eye has the ability to blend subdivided images together and the resulting image appears to be complete even though mechanical reel spaces 304 may be present. For example, when viewing a composite large screen television at close distance the individual images may appear discontinuous, however if the television is viewed from a slightly further distance the individual images blend and the entire screen is visually perceived as a whole and complete image.

The embodiment illustrated in FIG. 3B shows a partial game outcome is displayed containing a plurality of image symbols 300 but fewer than those required to form the complete contiguous scene 302. This type of game outcome may be implemented to further provide entertainment and gaming value to the player. In this way, the player will be able to view at least some of the contiguous scene 302 on a payline 122 and be rewarded. For example, in one embodiment the complete contiguous scene 302 is required for a top award, however should the player obtain one or more image symbols 300 that form at least a portion of the contiguous scene 302, the player may still receive an enhanced or increased award but possibly less than the top award.

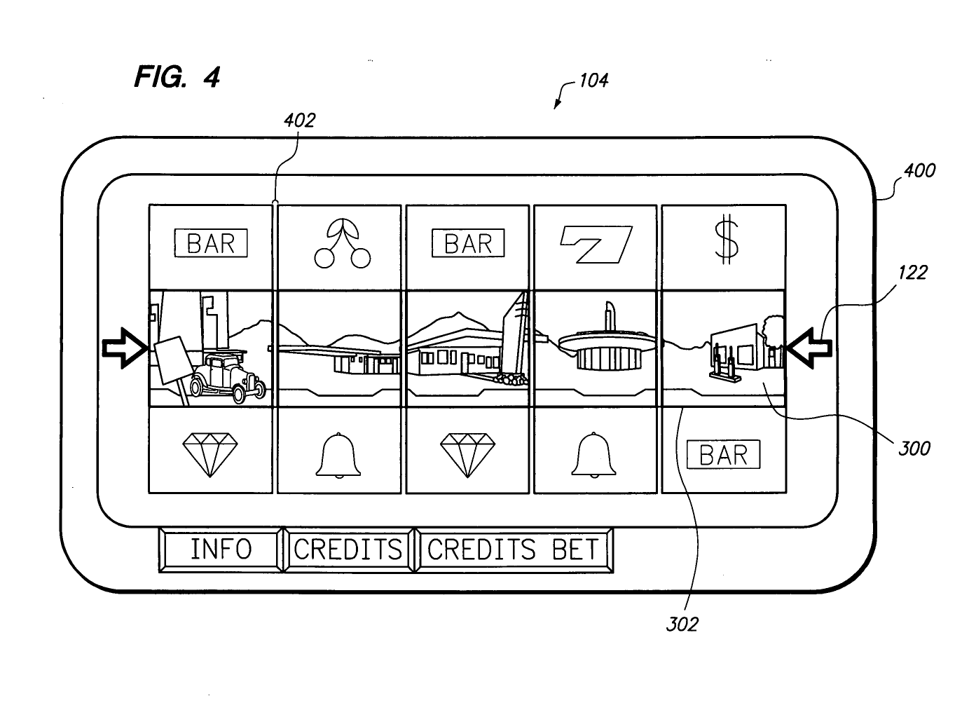

FIG. 4 illustrates a game display area showing video simulated reels. In this embodiment, the game display area 104 is a video display 400 that provides the player a visual representation of the game outcome. This arrangement of displaying game outcomes is well known in the art and is commonly referred to a “video reel slot game”.

In FIG. 4, the visual representation of the game outcome is similar to what has been recently described, however the game symbols 126 are not on actual electro-mechanical game reels 124 but rather comprise processor generated images of game reels. By using a simulated reel display, the gaming device is more flexible and adaptable to various configurations. For example, as indicated above, the mechanical reel spacing 304 between game reels is preferably minimized to enhance the player's perception of the contiguous scene 302. However, with an electro-mechanical reel system, the mechanical reel spacing 304 must accommodate the actual mechanical structure of the gaming reel assembly and therefore the mechanical reel spacing 302 is difficult to reduce. By using a simulated video version of the gaming reels, the video spacing 402 can be substantially reduced as compared to the electro-mechanical version of the gaming device because there are no physical restraints upon how close the simulated reels are placed next to one another.

Once the video reel spacing 402 is minimized, the contiguous scene 302 is much easier to visually appreciate and thus more complex images may be utilized as the contiguous scene 302. For example, in place of a panoramic sunset image, close video reel spacing 402 permits the use of an image with increased complexity such as an image depicting a 50's style dinner. Although the complexity of the scene is now substantially increased, the player can still appreciate the image because the image symbols 300 comprising the contiguous scene 302 are closer together and the content of the image is easily understood.

In the embodiment illustrated in FIG. 4, the contiguous scene 302 is comprised of individual image symbols 300 that are displayed in sequence and along a common payline 122. Although the payline 122 shown is horizontal, other payline configurations are possible and may be preferred to relate to different contiguous scenes. As previously discussed with reference to FIG. 3A, a player will appreciate and enjoy a game outcome that comprises a complete contiguous scene 302 when all the image symbols 300 are in alignment along a common payline 122. When such a game outcome is displayed, the gaming device 100 may provide enhanced or increased awards. It is contemplated that other than straight paylines may be linked with images, such as a diagonal payline. In addition, it is contemplated that the entire screen may be filled with an image when a top award or other winning combination has occurred. As such, the symbol locations above and/or below the payline 122 may also contain image elements which may or may not relate to the image elements in area 302.

In another embodiment similar to that illustrated in FIG. 3B, the video version of the present invention may further provided a partial game outcome that is displayed containing a plurality of image symbols 300 but fewer than those required to form the complete contiguous scene 302. This type of game outcome may be implemented to further provide entertainment and gaming value to the player. In this way, the player will receive some interaction from the gaming device when a significant portion of the contiguous scene 302 is displayed on a payline 122. For example, the complete contiguous scene 302 may be required for the top award, however should the player obtain image symbols 300 that form a substantial portion of the contiguous scene 302, the player may still receive an enhanced or increased award but possibly less than the top award.

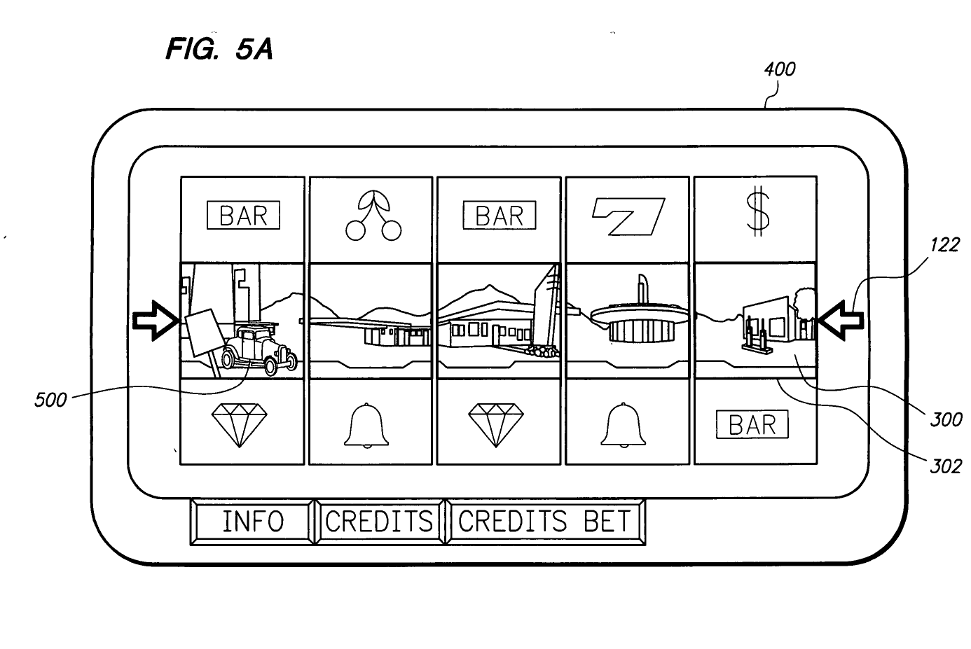

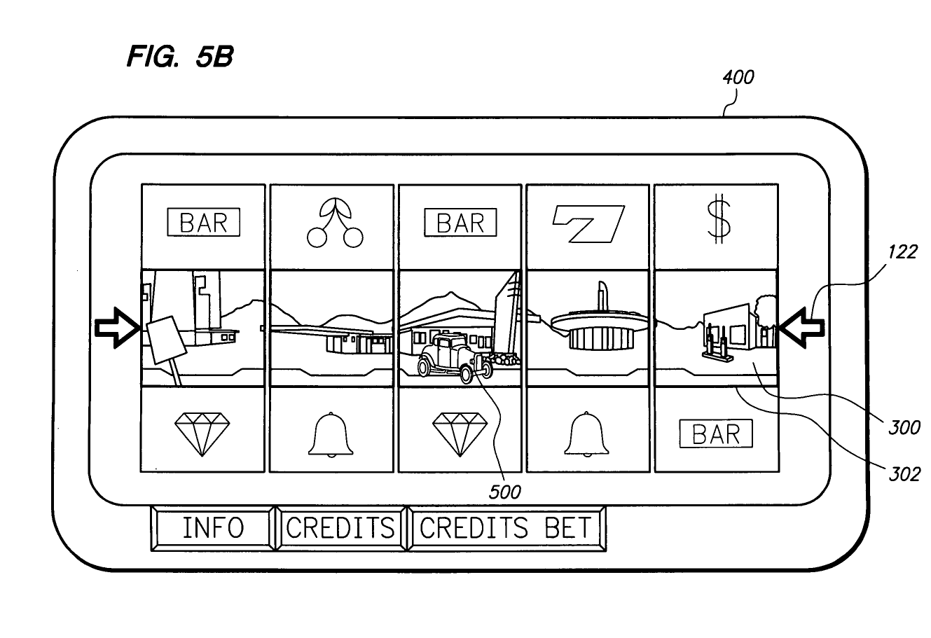

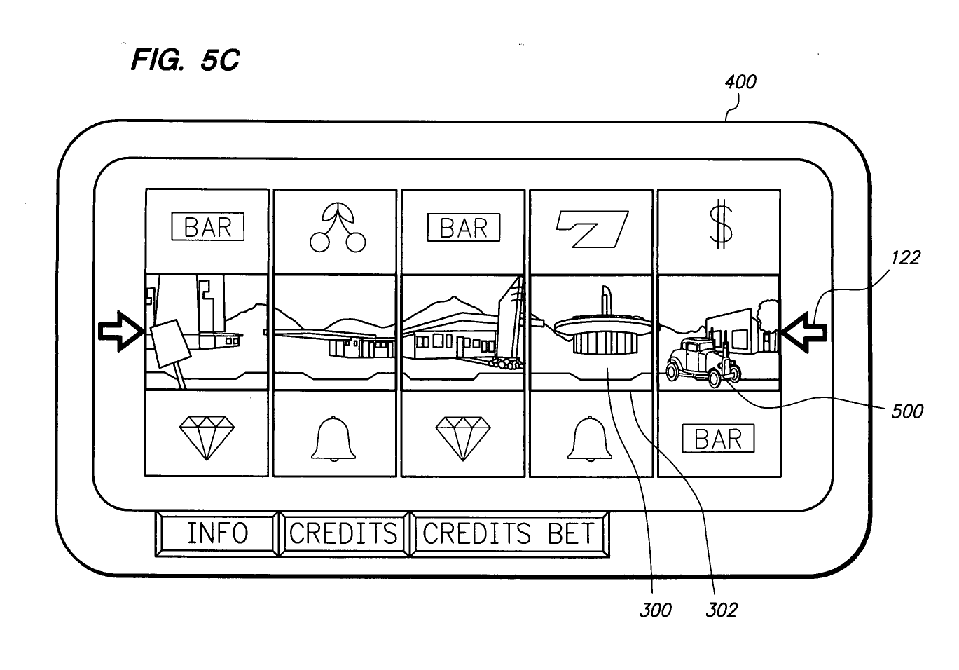

In one embodiment, the contiguous scene 302 may provide the player with increased entertainment value by incorporating movement, animation or a video sequence or display. The gaming device may provide a contiguous scene 302 as discussed above in connection with FIG. 4, that when aligned along a common payline certain portions of the scene are animated. Referring to FIGS. 5A-5C, this embodiment, a sequence of figures is provided which illustrates that all or a portion of the contiguous scene 302 may be animated to provide enhanced entertainment and visual stimulation to the player. In FIG. 5A, the game display area 104 is essentially the same as previously described, however now one or more elemental portions 500 of the scene are animated or incorporate some form of movement. As the sequence of FIGS. 5A-5C illustrates, the elemental portion 500 is shown in animated motion across the game display area 104.

Although the embodiment illustrated in FIGS. 5A-5C depict an elemental portion 500 being animated, the entire contiguous scene 302 may be animated. In addition, it is contemplated that an embedded video depicting various types of motion and or events may be incorporated from the image elements. Because the aspect ratio of the image formed from a winning payline is similar to that of video, a video clip may be show as a result of a winning combination of image elements. Thus, any number or amount of the image shown from the one or more composite image elements may incorporate animation or video, or both, and sound.

It is also contemplated that the animation and/or embedded video may be linked with the player's preferences through the player tracking functionality of the gaming device. In this way, when a game outcome is animated, the game processor may obtain information from the player tracking system and provide an animation or embedded video associated with the player's preferences stored in the player tracking system. Such player preference tracking and application systems are well known and commonly implemented in the gaming industry.

It is contemplated that the composite image, animation and/or embedded video may be linked to the theme of the gaming machine. In this manner, a player who selects a particular gaming machine to play based on the machines theme will be rewarded not only with the gaming machine payout but also theme related images, pictures, animation, video, audio, or a combination of two or more of these features. The images, pictures, animation, video would exist in a contiguous group of reel elements or spring such a group. This will also encourage repeat play and longer play sessions, all of which contribute to increase revenue from a machine.

It is further provided that a sub portion of the contiguous scene 302 may be animated when fewer than all of the image symbols are in alignment along a common payline. As described above, this scenario may provide additional entertainment and gaming interaction with the player and potentially enhanced or increased awards.

Additionally, the use of animation across a complete scene has the further benefit in that a player may easily ascertain that they have obtained a winning game outcome. This is most beneficial because some players do not realize that they have a winning outcome or why they have a winning outcome unless the gaming device changes state and provides some substantially obvious form of notification that a winning outcome has been obtained. With the method and apparatus described herein, players can readily see how close they were to receiving a winning outcome because a player can readily appreciate which image element were missing from the overall completed scene.

In still another embodiment, when the contiguous scene is displayed along a payline, the contiguous scene may morph and enlarge to occupy a substantial portion of the game display area. Morphing is a well known and common term in the computer arts and in basic form, it means to graphically transform or change form. In this respect, the contiguous scene that occupies portions of the game display along a payline is contemplated to transform in size and magnitude to occupy a larger portion of the game display area. This provides the player with greater excitement and is a further enhancement to the gaming experience. The morphing environment also provides an increase in the entertainment/gaming value the player receives.

Further, the morphing scene, or any other image or animation scene, may also provide a portal in which the player enters a bonus round for extended play. Bonus rounds are well known and thus not described in detail herein.

Another embodiment incorporates the aspects of the present invention in to a conversion kit. A conversion kit is a product that comprises components that essentially retrofit, update and transform an existing gaming device into a device with a modem game display area, a different theme, enhanced graphics and possibly new game play methods. For example (referring to FIG. 1), in a common conversion kit, the gaming device is updated by replacing various components such as for example the upper display area 114, lower display area 116, game display area 104, game symbols 124 and other embellishments (not shown) such as lights, buttons etc. The conversion kit may also include updated game processor instructions or software. The present invention may be combined with such a conversion kit, such that the game symbols that are replaced include the contiguous scene and associated image symbols on a reel. In one embodiment the same mechanical reel is utilized but with one or more images on each reel and such that at least one reel combination results in two adjacent reel positions displaying a composite image formed from two or more image elements on the reel. This provides the benefit of significantly changing the look and feel of the game to the player because not only is the top and belly glass of the machine changed, but so too are the reels which the player actually views. In addition, the reels now possess a unique image displayed for winning combinations that further increases player enjoyment. These benefits are realized without having to replace the machine. It is contemplated that the conversion kit may be utilized while still utilizing the same math (game outcome probabilities) that were programmed into the slot machine prior to the conversion.

As will now be apparent, gaming devices fabricated according to the teachings of the invention afford a number of advantages over known gaming devices limited to traditional game symbols and display of game outcomes.

Firstly, incorporating a plurality of individual images that when displayed on a common payline present the player with enhanced entertainment value and increased excitement upon receiving a particular game outcome. Thus, instead of a player becoming disinterested by receiving the same set of game symbols over and over again, the present invention provides a player with unique symbols that combine with one another to form a game outcome, thus anticipation and excitement are maintained.

Secondly, by providing a contiguous scene as a game outcome and subsequently animating the scene or portions thereof, player anticipation and excitement are substantially increased. The result being that the player will enjoy and desire playing the gaming device for extended periods of time, which will increase revenue.

Thirdly, the aspects of the invention may be applied and retrofitted to existing and previously outdated gaming devices. By performing such an update to the gaming device, new life is imparted into the machine and by further incorporating the enhanced image symbols, the players will enjoy the increased entertainment value of the gaming device.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A gaming device comprising:
a housing configured to enclose a game display area, the game display area comprising an opening in the housing;
a payline designator associated with the game display area;
a two or more reels viewable through the game display area;
two or more image elements on two or more reels, wherein when the two or more image elements are combined a composite image is formed;
a game processor configured to generate game outcome;
two or more stepper motor configured to spin an associated reel to cause the reels to display the game outcome though the game display area, wherein at least one game outcome comprises a composite image formed from two or more image elements on the reels.

2. The gaming device of claim 1, wherein a top award is associated with all of the reels displaying a game outcome that comprises a composite image formed from an image element contributed from each reel.

3. The gaming device of claim 2, wherein the composite image is related to a theme associated with the gaming device.

4. The gaming device of claim 1, wherein the game outcome comprises a composite image that contains less than all of the image elements.

5. The gaming device of claim 1, further comprising two or more different image elements located on two or more reels, which may be combined based on game outcomes to form a different composite image.

6. The gaming device of claim 1, further comprising two or more different image element located on two or more reels such that at least one game outcome comprises two composite images being shown through the game display area.

7. A method of presenting a game and indicating a top award to player comprising:
providing a gaming machine having two or more physical or two or more video simulated reels;
accepting a wager from a player;
generating a game outcome;
displaying the game outcome to the player on the having two or more physical reels or two or more video simulated reels;
providing an award to the player if the game outcome displayed to the player comprises a composite image formed from two or more adjacent image elements displayed on the two or more physical reels or two or more video simulated reels.

8. The method of claim 7, wherein the composite image comprises or changes into an animate or video scene.

9. The method of claim 7, wherein the composite image is associated with a player preference.

10. The method of claim 7, wherein the composite image is formed from two or more image elements located on adjacent reels of the two or more physical reels or two or more video simulated reels.

11. The method of claim 7, wherein, a top award is awarded to the player if the composite image is formed from image element formed from image elements located on all reels of the two or more physical reels or two or more video simulated reels.

12. A retrofit kit for retrofitting a slot type gaming machine, to permit display of a composite scene as a game outcome, comprising:
top glass having a theme associated therewith;
belly glass having the theme associated therewith;
two or more reel graphics sheet associated with each reel of the gaming machine configured to replace or cover pre-existing reel graphics, wherein at least two of the reel graphics sheets comprise:
two or more symbols printed on each reel graphic sheets;
one or more image elements printed on at least two of the reel graphic sheets, wherein the image elements are associated with the theme;
wherein the two or more reel graphics sheets are configured to display a composite image formed from at least two of the image elements printed on the reel graphic sheets.

13. The kit of claim 12, further comprising audio data associated with the theme.

14. The kit of claim 12, further comprising two or more reels.

15. The kit of claim 12, wherein the top glass or the belly glass further includes a top award payout amount printed thereon that is associated with a game outcome that displays the composite image displayed across all reels.

16. A method for retrofitting a slot type gaming machine comprising:
replacing a top glass element of the gaming machine;
replacing a belly glass element of the gaming machine;
replacing or covering each existing reel graphics with reel graphic replacements wherein the reel graphics replacements include at least one image element on each reel graphics replacement;
arranging the reel graphic replacements and the reels in the gaming machine such that a winning game outcome results in at least one image element from each reel being displayed in a payline to thereby form a composite image.

17. The method of claim 16, wherein the top glass, the belly glass and the image elements are related to a common theme.

18. The method of claim 16, further comprising replacing an audio file with a new audio file.
